(19) United States
(12) Patent Application Publication
(10) Pub. No.: US 2018/0364041 A1
(43) Pub. Date: Dec. 20, 2018

(54) MULTI-DIRECTIONAL MAGNETIC LEVELING DEVICE AND METHOD

(71) Applicants: Reginald Rice, Brandywine, MD (US); Reginald G. Rice, JR., Brandywine, MD (US)

(72) Inventors: Reginald Rice, Brandywine, MD (US); Reginald G. Rice, JR., Brandywine, MD (US)

(21) Appl. No.: 16/012,746

(22) Filed: Jun. 19, 2018

Related U.S. Application Data
(60) Provisional application No. 62/522,068, filed on Jun. 19, 2017.

(51) Int. Cl. G01C 9/28; G01C 9/34

(52) U.S. Cl. CPC G01C 9/28; G01C 9/34

(57) ABSTRACT

A leveling tool useful for determining levelness with multiple inclinations is disclosed herein. The leveling tool includes a level frame having four flat exterior faces able to be placed against a workpiece, four transparent reservoirs containing fluid and air, and magnets integrated within the level frame. The reservoirs are oriented at angles of zero, thirty, forty-five, and ninety degrees relative to one of the exterior faces, respectively. This variety of exterior faces and angled reservoirs allows the reservoirs to be used to indicate level of a workpiece if the workpiece is oriented at any summation of zero, thirty, forty-five, and ninety degrees of level. The magnets within the level frame allows the level frame to be removably coupled to a ferrous workpiece.

### CROSS-REFERENCE TO RELATED APPLICATION(S)

The present application is related to and claims priority to U.S. Provisional Patent Application No. 62/522,068 filed Jun. 19, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of hand tools of existing art and more specifically relates to leveling devices.

### RELATED ART

In construction and related fields, it is frequently desirable and necessary to orient structural members in a manner which is level with true horizontal. In other situations, it may be likewise necessary to orient members at a particular angle to true horizontal. Leveling in this way is necessary because it allows engineers and contractors to maintain reference points for making measurements and placing adjacent structural members.

Commonly, leveling tools are constructed in a way that allows them to orient a member to either zero or ninety degrees from true horizontal. However, other angles are often needed in the construction industry, particularly for roof trusses, braces, railings, and similar structures. A suitable solution is desired.

U.S. Pat. No. 7,152,335 to Michael P. Nichols relates to an omnidirectional torpedo level having magnetic mounts and adjustable protractor. The described omnidirectional torpedo level having magnetic mounts and adjustable protractor includes an omnidirectional torpedo level composed of non-ferrous material having a central web and parallel side flanges defining a torpedo level geometry. The central web and side flanges define windows within which are mounted vertical and horizontal tubular spirit level elements that permit selective orientation of the side flanges to determine when surfaces being engaged by the side flanges are either vertically or horizontally oriented. A rotary protractor is mounted to the central web and contains a spirit level tube for accurate positioning of the side flanges with respect to the selected angle of the protractor.

### SUMMARY OF THE INVENTION

In view of the foregoing disadvantages inherent in the known leveling device art, the present disclosure provides a novel multi-directional magnetic leveling device and method. The general purpose of the present disclosure, which will be described subsequently in greater detail, is to provide a multi-directional magnetic leveling device and method.

A leveling tool is disclosed herein. The leveling tool includes a level frame having four flat exterior faces able to be placed against a workpiece, four transparent reservoirs containing fluid and air, and magnets integrated within the level frame. The exterior faces may be disposed perpendicularly to each other, such that they form a rectangle. The reservoirs may be disposed within the level frame such that they and their contents are visible to a user when one of the exterior faces is placed against a workpiece. The reservoirs are oriented at angles of zero, thirty, forty-five, and ninety degrees relative to one of the exterior faces, respectively. This variety of exterior faces and angled reservoirs allows the reservoirs to be used to indicate level of a workpiece if the workpiece is oriented at any summation of zero, thirty, forty-five, and ninety degrees of level. The magnets within the level frame allows the level frame to be removably coupled to a ferrous workpiece.

According to another embodiment, a method of leveling a workpiece is also disclosed herein. The method of leveling a workpiece includes providing the above-described leveling tool, placing one of the four exterior surfaces adjacent to the workpiece, examining the appropriate bubble reservoir to determine if the air is centered within the fluid, thereby indicating level, and optionally, adjusting the workpiece until the air is centered within the fluid.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a multi-directional magnetic leveling device and method, constructed and operative according to the teachings of the present disclosure.

FIG. 1 is a perspective view of the leveling tool during an ‘in-use’ condition, according to an embodiment of the disclosure.

FIG. 2 is a perspective view of the leveling tool of FIG. 1, according to an embodiment of the present disclosure.

FIG. 3 is a perspective view of the leveling tool of FIG. 1, according to an embodiment of the present disclosure.

FIG. 4 is a perspective view of the leveling tool of FIG. 1, according to an embodiment of the present disclosure.

FIG. 5 is a flow diagram illustrating a method of use for determining levelness of a workpiece, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a leveling device and more particularly to a multi-directional magnetic leveling device and method as used to improve the determination of levelness of a workpiece.

Generally, the leveling device is a multi-angle spirit level having magnets able to attaches to steel surfaces and structures. The inclusion of magnets enables individuals to level ferromagnetic objects in a hands-free manner quickly and easily. The leveling device has a cuboid body, with six faces related perpendicularly, making leveling from different sides of the level intuitive to a user. The magnets may be included on multiple sides of the level, further allowing users to attach the level to all metal surfaces from multiple sides. A preferred embodiment includes magnets positioned on all six sides of the cuboid body of the level. The leveling device is advantageous for use by any craftsman who must level a ferromagnetic object, such as electricians, ironworkers, steamfitters, and metal stud workers, by reducing the need to use both hands or more than one individual to level an object. In a preferred embodiment, the cuboid level may measure approximately nine inches long, one-and-five-eighths inched tall, and five-eighths of an inch thick. The level may contain four glass level bulbs and nine magnets for attaching to a steel structure from any side. The four bulbs may be oriented at zero, thirty, forty-five, and ninety degrees relative to one side of the level respectively. The exact specifications may vary.

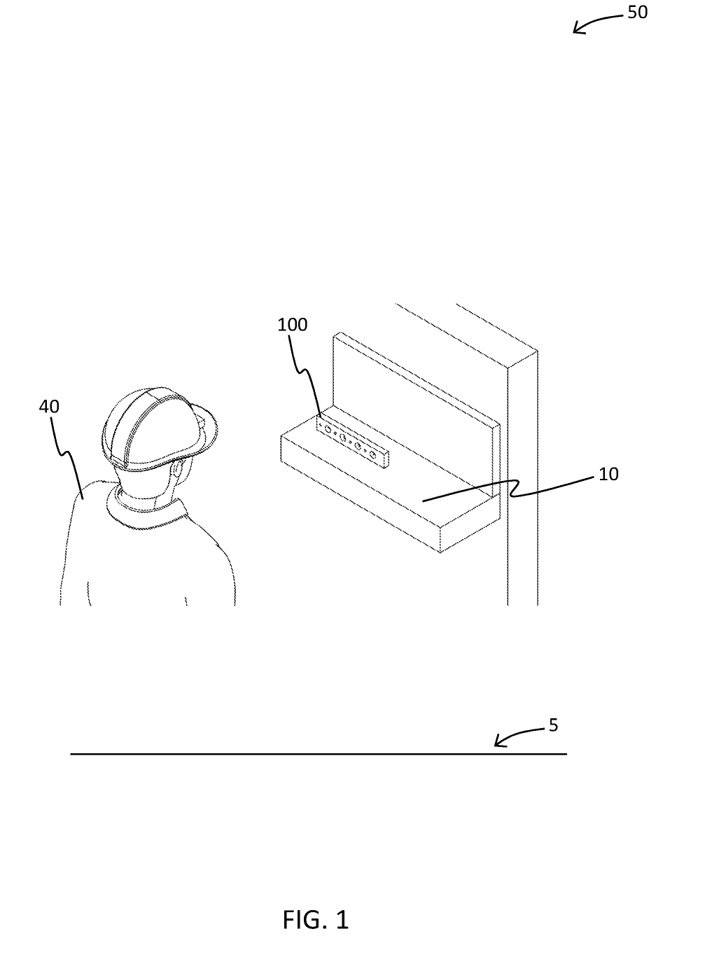

Referring now more specifically to the drawings by numerals of reference, there is shown in FIGS. 1-4, various views of a tool 100.

FIG. 1 shows a bubble level during an ‘in-use’ condition 50, according to an embodiment of the present disclosure. Here, the bubble level may be beneficial for use by a user 40 to orient a member at a desired angle relative to true horizontal. As illustrated, bubble level 100 may be useful for measuring inclinations of a ferromagnetic surface 10 relative to a ground 5.

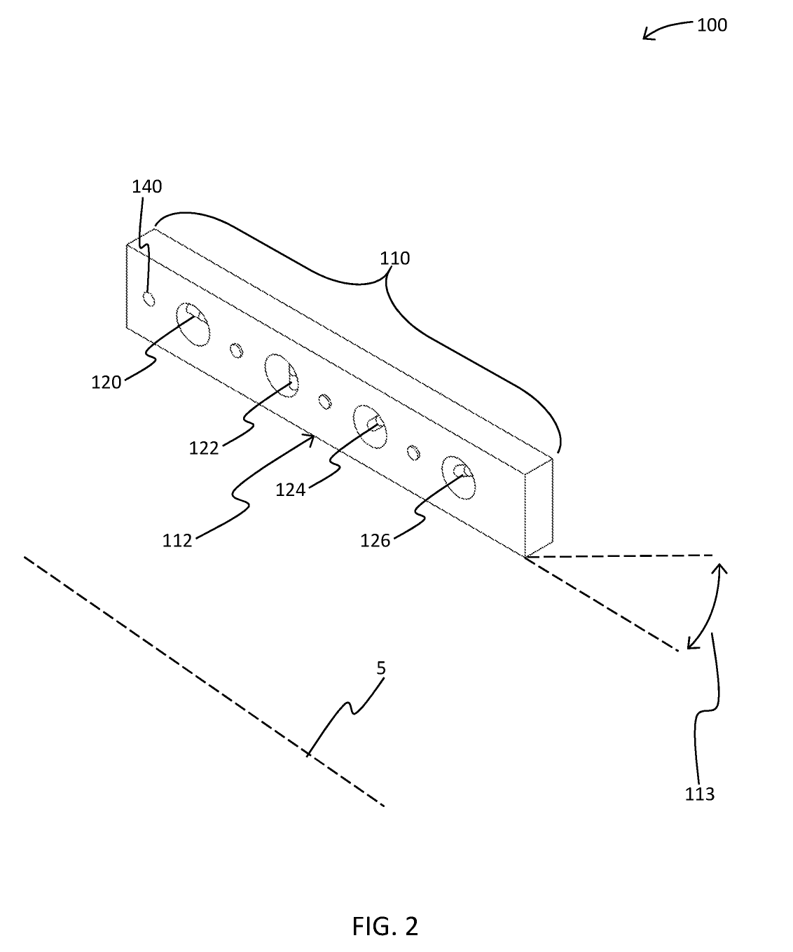

FIG. 2 shows the bubble level of FIG. 1, according to an embodiment of the present disclosure. The bubble level 100 may include a frame 110, a horizontal bubble tube 120, a vertical bubble tube 122, a 45-degree bubble tube 124, a 30-degree bubble tube 126, and at least one first magnet 140. The level-frame 110 may include a first flat surface 112, which may be configured to rest against the ferromagnetic surface 10 (FIG. 1), in which event the first flat surface 112 may define a first surface inclination 113. The horizontal bubble tube 120 may be fixed to the level-frame 110 and may be configured to indicate when the first surface inclination 113 is horizontal. Likewise, the vertical bubble tube 122 may also be fixed to the level-frame 110 and may be configured to indicate when the first surface inclination 113 is vertical. The 45-degree bubble tube 124 may be fixed to the level-frame 110 and may be configured to indicate when the first surface inclination 113 is 45 degrees from the ground 5. The 30-degree bubble tube 126 may be fixed to the level-frame 110 and may be configured to indicate when the first surface inclination 113 is 30 degrees from the ground 5. The horizontal bubble tube 120, the vertical bubble tube 122, the 45-degree bubble tube 124, and the 30-degree bubble tube 126 may be placed in a row linearly, such that all four may be viewed simultaneously by the user 40 (FIG. 1). Each of the horizontal bubble tube 120, the vertical bubble tube 122, the 45-degree bubble tube 124, and the 30-degree bubble tube 126 may be cylindrical and may have a transparent tubular sidewall defining an interior cavity containing fluid and air. Additionally, each of the horizontal bubble tube 120, the vertical bubble tube 122, the 45-degree bubble tube 124, and the 30-degree bubble tube 126 may further include indicia to indicate deviation from level. The at least one first magnet 140 may be fixed to the level-frame 110 and may be configured to magnetically couple the ferromagnetic surface 10 (FIG. 1) to the first flat surface 112 of the level-frame 110.

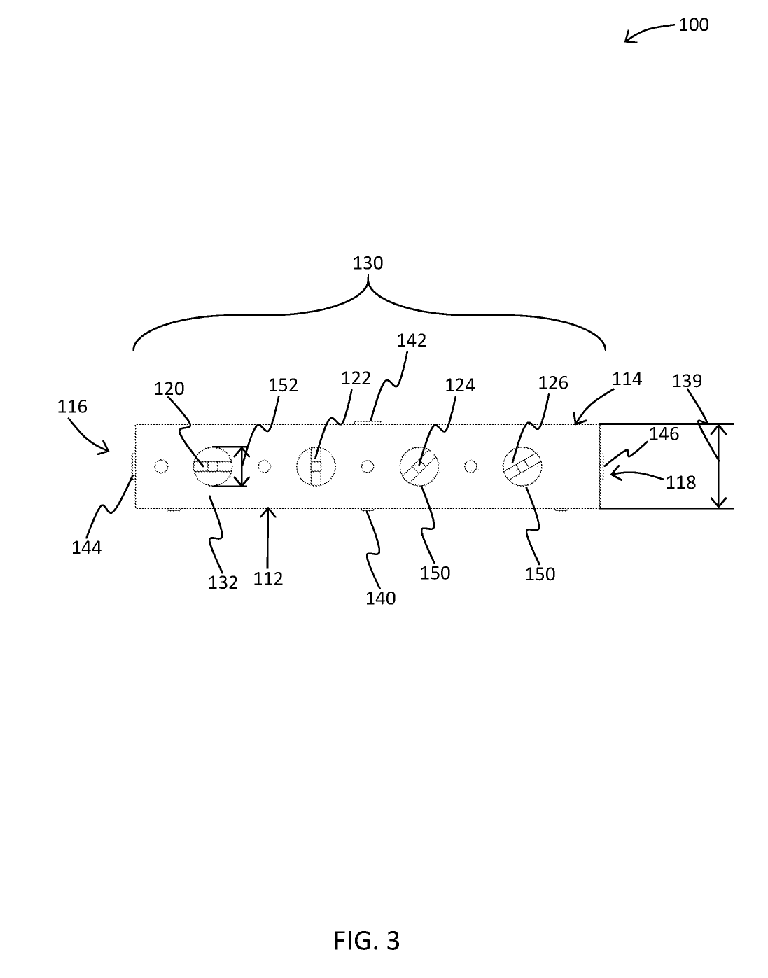

FIG. 3 is a side perspective view of the bubble level of FIG. 1, according to an embodiment of the present disclosure. Preferably, the level-frame 110 may be shaped as a cuboid 130 and may further include a second flat surface 114, a third flat surface 116, a fourth flat surface 118, each being configured to alternately rest against the ferromagnetic surface 10 (FIG. 1). The first flat surface 112, the second flat surface 114, the third flat surface 116, and the fourth flat surface 118 may be adjacently joined, and in a preferred embodiment may be joined perpendicularly. The bubble level 100 may further include at least one second magnet 142, at least one third magnet 144, and at least one fourth magnet 146. At least one second magnet 142 may be fixed to the level-frame 110 and may be configured to magnetically couple the ferromagnetic surface 10 (FIG. 1) to the second flat surface 114 of the level-frame 110. Likewise, at least one third magnet 144 may be fixed to the level-frame 110 and may be configured to magnetically couple the ferromagnetic surface 10 (FIG. 1) to the third flat surface 116 of the level-frame 110. At least one fourth magnet 146 may be fixed to the level-frame 110 and may be configured to magnetically couple the ferromagnetic surface 10 (FIG. 1) to the fourth flat surface 118 of the level-frame 110. The cuboid 130 of the level-frame 110 may be substantially solid, and the level-frame 110 may further include a plurality of apertures 150 extending through level-frame 110. The horizontal bubble tube 120, the vertical bubble tube 122, the 45-degree bubble tube 124, and the 30-degree bubble tube 126 may each be positioned within one of the plurality of apertures 150. Preferably, each of the plurality of apertures 150 may be cylindrical in shape and may have an aperture-diameter 152 measuring three-quarters of an inch, respectively. The at least one first magnet 140 may be embedded within the level-frame 110 and may be flush with the first flat surface 112 Likewise, the at least one second magnet 142 may be embedded within the level-frame 110 and may be flush with the second flat surface 114. The at least one third magnet 144 may be embedded within the level-frame 110 and may be flush with the third flat surface 116. The at least one fourth magnet 146 may be embedded within the level-frame 110 and may be flush with the fourth flat surface 118. The cuboid 130 may be defined by a height 139 measured between the second flat surface 114 and the fourth flat surface 118. The height 139 may measure one-and-five-eighths inches in one embodiment.

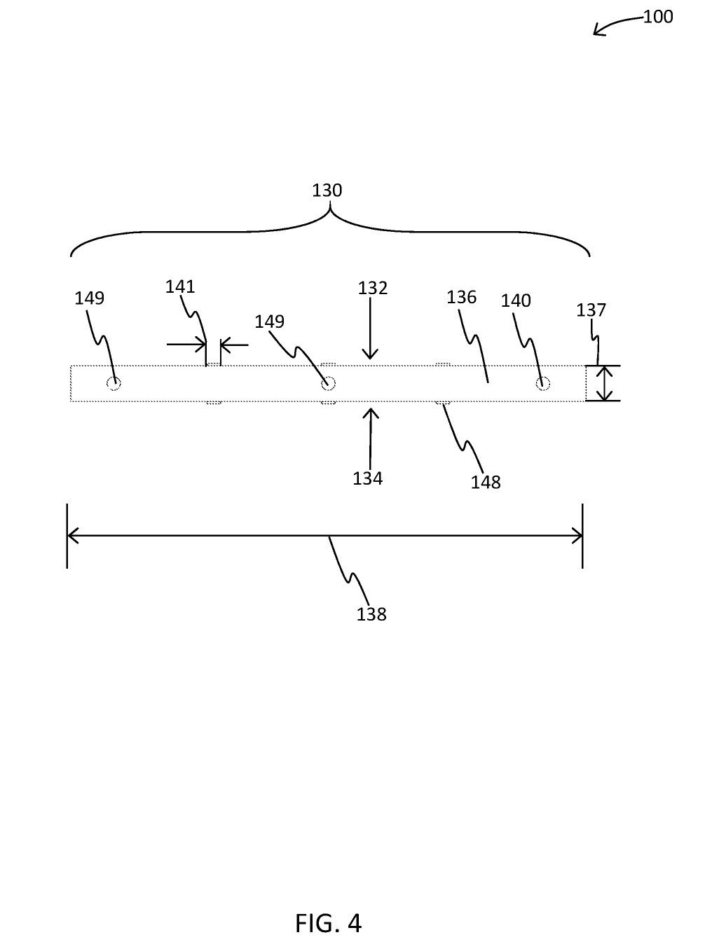

FIG. 4 is a top perspective view of the bubble level of FIG. 1, according to an embodiment of the present disclosure. Cuboid 130 further includes a second flat face 134, such that the second flat face 134 may be opposite the first flat face 132. Accordingly, the first flat face 132 and the second flat face 134 may opposite and parallel sides of the cuboid 130. Plurality of apertures 150 may extend between the first flat face 132 and the second flat face 134. Further, the horizontal bubble tube 120 (FIG. 3), the vertical bubble tube 122 (FIG. 3), the 45-degree bubble tube 124 (FIG. 3), and the 30-degree bubble tube 126 (FIG. 3) may each be recessed between the first flat face 132 and the second flat face 134. The first flat surface 112 (FIG. 3), the second flat surface 114 (FIG. 3), the third flat surface 116 (FIG. 3), and the fourth flat surface 118 (FIG. 3) may be adjacently joined and may define a rectangular perimeter 136 about the cuboid 130 between and the first flat face 132 and the second flat face 134. As shown, the at least one first magnet 140 may include at least three magnets 149 which may be evenly distributed along the first flat surface 112 between the second flat surface 114 and the fourth flat surface 118. The cuboid 130 may have a thickness 137 measured between the first flat face 132 and the second flat face 134. In one embodiment, the thickness 137 may be five-eighths of an inch. The cuboid 130 may also have a length 138 measured between the first flat surface 112 and the third flat surface 116. In one embodiment, the length 138 may be approximately nine inches. The bubble level 100 may further include at least one fifth magnet 148 fixed to the level-frame 110, which may be configured to magnetically couple the ferromagnetic surface 10 (FIG. 1) to the first flat face 132 of the level-frame 110, or alternately, the second flat face 134 of the level-frame 134. The at least one first magnet 140, the at least one second magnet 142 (FIG. 3), the at least one third magnet 144 (FIG. 3), the at least fourth first magnet (FIG. 3), and the at least one fifth magnet 148 each include at least three evenly distributed magnets 149, respectively. In a preferred embodiment, the at least one first magnet 140, the at least one second magnet 142 (FIG. 3), the at least one third magnet 144 (FIG. 3), the at least fourth first magnet (FIG. 3), and the at least one fifth magnet 148 may all be cylindrical in shape and may each have a magnet-diameter 141 measuring one-quarter of an inch.

Upon reading this specification, it should be appreciated that, under appropriate circumstances, considering such issues as user preferences, design preference, structural requirements, marketing preferences, cost, available materials, technological advances, etc., other structural arrangements such as, for example, additional structural features and enhancements, beveled edges, indicia, alternative magnets shapes and quantities, etc., may be sufficient.

Those with ordinary skill in the art will now appreciate that upon reading this specification and by their understanding the art of construction and leveling as described herein, methods of leveling objects, will be understood by those knowledgeable in such art.

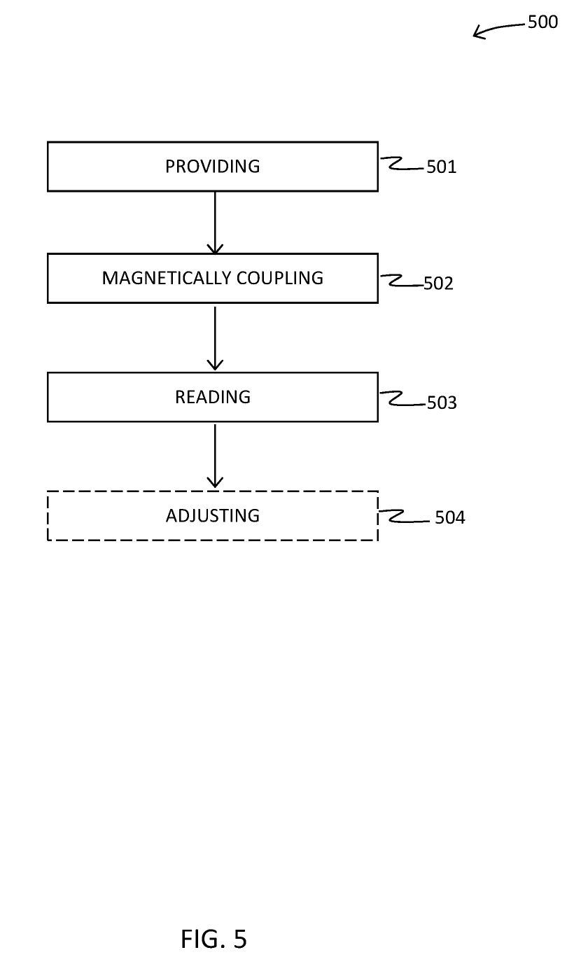

FIG. 5 is a flow diagram illustrating a method for determining levelness of a workpiece, according to an embodiment of the present disclosure. In particular, the method for determining levelness of a workpiece 500 may include one or more components or features of the tool 100 as described above. As illustrated, the method for determining levelness of a workpiece 500 may include the steps of: step one 501, providing a bubble level including a level-frame including a first flat surface, said first flat surface being configured to rest against the ferromagnetic surface, said first flat surface defining a first surface inclination, a horizontal bubble tube fixed to the level-frame and configured to indicate when the first surface inclination is horizontal, a vertical bubble tube fixed to the level-frame and configured to indicate when the first surface inclination is vertical, a 45-degree bubble tube fixed to the level-frame and configured to indicate when the first surface inclination is 45 degrees from the ground, a 30-degree bubble tube fixed to the level-frame and configured to indicate when the first surface inclination is 30 degrees from the ground, and a first plurality of magnets fixed to the level-frame and configured to magnetically couple the ferromagnetic surface to the first flat surface of the level-frame; step two 502, magnetically coupling the first flat surface to the workpiece; step three 503, reading whether the horizontal bubble tube is level to the ground; and step four 540, adjusting the workpiece until the horizontal bubble tube reads as horizontal to the ground.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for determining levelness of a workpiece, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bubble level for measuring inclinations of a ferromagnetic surface relative to a ground, the bubble level comprising:
a level-frame including a first flat surface, said first flat surface being configured to rest against the ferromagnetic surface, said first flat surface defining a first surface inclination;
a horizontal bubble tube fixed to the level-frame and configured to indicate when the first surface inclination is horizontal;
a vertical bubble tube fixed to the level-frame and configured to indicate when the first surface inclination is vertical;
a 45-degree bubble tube fixed to the level-frame and configured to indicate when the first surface inclination is 45 degrees from the ground;
a 30-degree bubble tube fixed to the level-frame and configured to indicate when the first surface inclination is 30 degrees from the ground; and
at least one first magnet fixed to the level-frame and configured to magnetically couple the ferromagnetic surface to the first flat surface of the level-frame.

2. The bubble level of claim 1, wherein the level-frame is shaped as a cuboid and further includes a second flat surface, a third flat surface, a fourth flat surface, a first flat face, and a second flat face, each being configured to alternately rest against the ferromagnetic surface, the first flat face and the second flat face defining opposite sides of the cuboid and the first, second, third, and fourth flat surfaces adjacently joined, and defining a rectangular perimeter about the cuboid between and the first flat face and the second flat face.

3. The bubble level of claim 2, further comprising:
at least one second magnet fixed to the level-frame, and configured to magnetically couple the ferromagnetic surface to the second flat surface of the level-frame;
at least one third magnet fixed to the level-frame, and configured to magnetically couple the ferromagnetic surface to the third flat surface of the level-frame; and
at least one fourth magnet fixed to the level-frame and configured to magnetically couple the ferromagnetic surface to the fourth flat surface of the level-frame.

4. The bubble level of claim 2, wherein cuboid of the level-frame is substantially solid, and the level-frame further includes a plurality of apertures extending through and between the first flat face and the second flat face; and
wherein each of the horizontal bubble tube, the vertical bubble tube, the 45-degree bubble tube, and the 30-degree bubble tube are positioned within one of the plurality of apertures.

5. The bubble level of claim 4, wherein each of the horizontal bubble tube, the vertical bubble tube, the 45-degree bubble tube, and the 30-degree bubble tube are recessed between or flush with the first flat face and the second flat face.

6. The bubble level of claim 5, wherein each of the plurality of apertures are cylindrical in shape and have an aperture-diameter measuring three-quarters of an inch, respectively.

7. The bubble level of claim 3, wherein the at least one first magnet is embedded within the level-frame, flush with the first flat surface.

8. The bubble level of claim 7, wherein the at least one first magnet includes at least three magnets evenly distributed along the first flat surface between the second flat surface and the fourth flat surface.

9. The bubble level of claim 7, wherein the at least one second magnet is embedded within the level-frame, flush with the second flat surface.

10. The bubble level of claim 9, wherein the at least one third magnet is embedded within the level-frame, flush with the third flat surface.

11. The bubble level of claim 10, wherein the at least one fourth magnet is embedded within the level-frame, flush with the fourth flat surface.

12. The bubble level of claim 2, wherein cuboid has a length measured between the first flat surface and the third flat surface, the length being approximately nine inches.

13. The bubble level of claim 12, wherein the cuboid has a height measured between the second flat surface and the fourth flat surface, the height being one-and-five-eighths inches.

14. The bubble level of claim 1, wherein the cuboid has a thickness measured between the first flat face and the second flat face, the thickness being five-eighths of an inch.

15. The bubble level of claim 3, wherein the further comprising at least one fifth magnet fixed to the level-frame, and configured to magnetically couple the ferromagnetic surface to the first flat face of the level-frame; and
wherein the at least one first magnet, the at least one second magnet, the at least one third magnet, the at least fourth first magnet, and the at least one fifth magnet each include at least three evenly distributed magnets, respectively.

16. The bubble level of claim 15, wherein the at least one first magnet, the at least one second magnet, the at least one third magnet, the at least fourth first magnet, and the at least one fifth magnet are all cylindrical in shape and have a magnet-diameter measuring one-quarter of an inch.

17. A multi-directional magnetic leveling device for measuring inclinations of a ferromagnetic surface relative to a ground, the multi-directional magnetic leveling device comprising:
a level-frame including a first flat surface, said first flat surface being configured to rest against the ferromagnetic surface, said first flat surface defining a first surface inclination;
a horizontal bubble tube fixed to the level-frame and configured to indicate when the first surface inclination is horizontal;
a vertical bubble tube fixed to the level-frame and configured to indicate when the first surface inclination is vertical;
a 45-degree bubble tube fixed to the level-frame and configured to indicate when the first surface inclination is 45 degrees from the ground;
a 30-degree bubble tube fixed to the level-frame and configured to indicate when the first surface inclination is 30 degrees from the ground; and
at least one first magnet fixed to the level-frame and configured to magnetically couple the ferromagnetic surface to the first flat surface of the level-frame;
wherein the level-frame is shaped as a cuboid and further includes a second flat surface, a third flat surface, a fourth flat surface, a first flat face, and a second flat face, each being configured to alternately rest against the ferromagnetic surface, the first flat face and the second flat face defining opposite sides of the cuboid and the first, second, third, and fourth flat surfaces adjacently joined, and defining a rectangular perimeter about the cuboid between and the first flat face and the second flat face. further comprising:
at least one second magnet fixed to the level-frame, and configured to magnetically couple the ferromagnetic surface to the second flat surface of the level-frame;
at least one third magnet fixed to the level-frame, and configured to magnetically couple the ferromagnetic surface to the third flat surface of the level-frame; and
at least one fourth magnet fixed to the level-frame, and configured to magnetically couple the ferromagnetic surface to the fourth flat surface of the level-frame;
wherein cuboid of the level-frame is substantially solid, and the level-frame further includes a plurality of apertures extending through and between the first flat face and the second flat face;
wherein each of the horizontal bubble tube, the vertical bubble tube, the 45-degree bubble tube, and the 30-degree bubble tube are positioned within one of the plurality of apertures;
wherein each of the horizontal bubble tube, the vertical bubble tube, the 45-degree bubble tube, and the 30-degree bubble tube are recessed between or flush with the third flat surface and the fourth flat surface;
wherein each of the plurality of apertures are cylindrical in shape, and have a diameter measuring three-quarters of an inch, respectively;
wherein the at least one first magnet is embedded within the level-frame, flush with the first flat surface;
wherein the at least one first magnet includes at least three magnets evenly distributed along the first flat surface between the second surface and the fourth surface;
wherein the at least one second magnet is embedded within the level-frame, flush with the second flat surface;
wherein the at least one third magnet is embedded within the level-frame, flush with the third flat surface;
wherein the at least one fourth magnet is embedded within the level-frame, flush with the fourth flat surface;
wherein cuboid has a length measured between the first flat surface and the third flat surface, the length being approximately nine inches;
wherein the cuboid has a height measured between the second flat surface and the fourth flat surface, the height being one-and-five-eighths inches;
wherein the cuboid has a thickness measured between the first flat face and the second flat face, the thickness being five-eighths of an inch;
further comprising at least one fifth magnet fixed to the level-frame, and configured to magnetically couple the ferromagnetic surface to the first flat face of the level-frame;
wherein the at least one first magnet, the at least one second magnet, the at least one third magnet, the at least fourth first magnet, and the at least one fifth magnet each include at least three evenly distributed magnets, respectively; and
wherein the at least one first magnet, the at least one second magnet, the at least one third magnet, the at least fourth first magnet, and the at least one fifth magnet are all cylindrical in shape and have a diameter measuring one-quarter of an inch.

18. A method of measuring inclinations of a ferromagnetic surface relative to a ground, the method comprising the steps of:
providing a bubble level including
a level-frame including a first flat surface, said first flat surface being configured to rest against the ferromagnetic surface, said first flat surface defining a first surface inclination,
a horizontal bubble tube fixed to the level-frame and configured to indicate when the first surface inclination is horizontal,
a vertical bubble tube fixed to the level-frame and configured to indicate when the first surface inclination is vertical,
a 45-degree bubble tube fixed to the level-frame and configured to indicate when the first surface inclination is 45 degrees from the ground,
a 30-degree bubble tube fixed to the level-frame and configured to indicate when the first surface inclination is 30 degrees from the ground, and
a first plurality of magnets fixed to the level-frame and configured to magnetically couple the ferromagnetic surface to the first flat surface of the level-frame;
magnetically coupling the first flat surface to the workpiece; and
reading whether the horizontal bubble tube is level to the ground.

19. The method of claim 19, further comprising the step of adjusting the workpiece until the horizontal bubble tube reads as horizontal to the ground.
